(19) United States
(12) Patent Application Publication
(10) Pub. No.: US 2007/0156839 A1
(43) Pub. Date: Jul. 5, 2007

(54) Web services for wireless pervasive devices

(75) Inventors: Vishal Singh Batra, Noida (IN); Nipun Batra, Noida (IN)

Correspondence Address: IBM ALMADEN (AVE);c/o LAW OFFICE OF ANTHONY ENGLAND, P.O. BOX 5307, AUSTIN, TX, 78763, US

(73) Assignee: International Business Machines Corporation

(21) Appl. No.: 11/321,670

(22) Filed: Dec. 29, 2005

(51) Int. Cl. G06F 15/16; G06F 15/173

(52) U.S. Cl. 709/217; 709/223

(57) ABSTRACT

A computer-implemented method, apparatus and computer program product for providing an interface between a client application and a web service is disclosed. A first request from the client application is received. The first request is associated with a response schema specifying a format for responding to the client application. A service request is sent to the web service dependent on the first request. An output from the web service is obtained responsive to the service request. The output is in a predefined output format associated with the web service. The output is transformed to conform to the response schema. The transformed output is provided to the client application.

### FIELD OF THE INVENTION

The present invention relates to web services for wireless pervasive devices.

### BACKGROUND OF THE INVENTION

In the recent years there has been a significant rise in web service technology-based application deployment and integration. Such services should be accessible by a wide variety of client applications hosted on platforms that may range from high-end servers to pervasive devices such as mobile telephones and personal digital assistants (PDAs). A web service is deployed over Hyper Text Transfer Protocol (HTML) and the Extensible Markup Language (XML) data model to exchange messages, thereby making the service language and platform independent and accessible by a wide variety of client applications hosted on different platforms. Besides language independence, the XML data model also offers a document-based interaction, enabling aggregate and complex data structures to be exchanged between the service and client applications in a single interaction. While the service providers may offer generic service response to cater to the requirements of diverse client applications, it is the responsibility of the client application to extract data relevant to it from the service response.

For example, a Web Service is considered that provides addresses of ATM locations near a given zip and country code. For a requested zip code of ‘134’, the web service may provide a response such as that shown in FIG. 1, including information about the location of ATMs that accept AMX, VISAA, MASTCARD and DNERCARD cards (corresponding to American Express™, Visa™, Mastercard™ and Diners Club™ cards). However, the client application making the request may only be interested in ATM locations accepting AMX cards, and may thus require only a limited subset of the response. FIG. 2 shows the subset of the web service response that is of interest to the client application, i.e. only the information relating to AMX cards.

Applications deployed on network-enabled pervasive devices can access and exchange data with the web services to offer desired information to the end user on demand. However, the pervasive devices may experience excess airtime and power consumption due to networking and parsing of excess data provided by such generic services. While several techniques have been developed that allow server applications to be sensitive to the device capacity while providing its response, these techniques have been focused on transforming the display elements to make the response compatible with the display capability of the client device [viz., T. Kwok et al. An efficient and systematic method to generate xslt stylesheets for different wireless pervasive devices, WWW, ACM Press, New York, USA, 2004, pp. 218-219; IBM WebSphere Transcoding Publisher Version 1.1: Extending Web Applications to the Pervasive World, IBM Redbook, 2000; A. Pashtan, S. Kollipara, M. Pearce, Adaptive Content for Wireless Web Services, IEEE Internet Computing, 2003, pp. 79-85].

As commercial, fee-based web services emerge, greater pervasive applications will be demanded by users to access these services for information or business, without compromising on the wireless device's resources. The information extraction from a large service response may create performance overheads for pervasive applications, for example in the cases described below.
1. A large response is transmitted to a pervasive device having limited network bandwidth and thus consuming a lot of device airtime and power.
2. The response XML may have a complex and deeply nested schema and thus make relevant information extraction slow due to the limited memory and processor speed of the wireless device.
3. The most severe overhead caused by the web service is to provide a response that is too big for the pervasive device to handle due to its limited memory. Such a service will initially consume airtime and incur a service fee, and will eventually cause the application to fail due to a memory error.

There is an ongoing need for methods that enable the efficient exploitation of the resources of client devices in interactions with web services.

### SUMMARY

Extensions to web service are provided that are transparent and external to the core business logic of the service, to enable the service to interact efficiently with pervasive applications and optimally utilize the limited resources of the pervasive device. The extended web service allows pervasive applications to ‘move’ (or offload) some computation tasks to the service to reduce the response size, and thus the airtime and power consumption, and be served only application-relevant data from the service.

According to one aspect of the invention there is provided a computer-implemented method for providing an interface between a client application and a web service. The method includes the step of receiving a first request from said client application. The first request is associated with a response schema specifying a format for responding to client application. A service request is sent to the web service dependent on said first request. An output is obtained from the web service responsive to the service request, and wherein the output is in a predefined output format associated with the web service. The output is transformed to conform to said response schema. The transformed output is provided to the client application.

According to other aspects of the invention, a computer system, apparatus and computer program product for providing an interface between a client application and a web service are provided.

### DESCRIPTION OF DRAWINGS

One or more embodiments of the invention will now be described with reference to the drawings, in which:

FIG. 1 is an example of a typical web service response;

FIG. 2 is a subset of the response of FIG. 1 that may be relevant to a wireless device;

FIG. 3 is a schematic block diagram of a system in which pervasive devices are able to access web services from one or more servers;

FIG. 4 is a flow chart illustrating steps performed by a client application in accessing a web service;

FIG. 5 is a flow chart showing an example of steps performed by a client application in obtaining the response of FIG. 2;

FIG. 6 is a flow chart illustrating the interaction of a client application with an extended web service;

FIG. 7 is a sample of an eXtensible Stylesheet Language (XSL) that may be used to filter and process the web service response in the extended web service of FIG. 6;

FIG. 8 is an example of a transformed service response; and

FIG. 9 is an example of a general-purpose computer system that may be used in the system of FIG. 3.

### DETAILED DESCRIPTION

In the arrangements described below, an extended web service allows applications running on pervasive devices to offload some computational tasks to the web service. Such offloading may reduce the size of the response received from the web service, thus reducing the airtime and power consumption of the pervasive device. The availability of the extended web service allows each application hosted on the pervasive device to have an associated benefit analysis policy to choose between the base and extended web service.

Web Service Environment

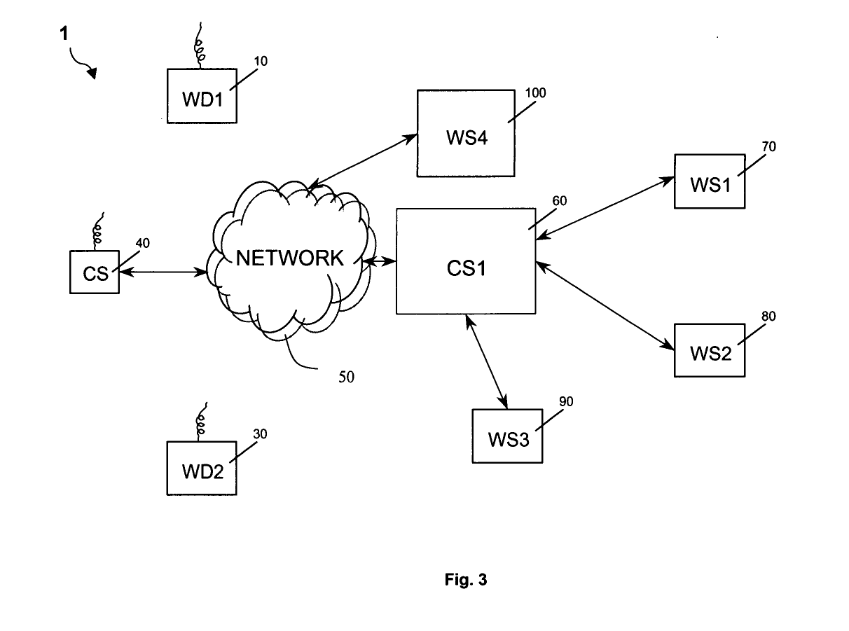

FIG. 3 shows a schematic block diagram of a web services system 1. The system 1 is simplified for the purposes of aiding understanding. A first pervasive wireless device (WD1) 10, such as a PDA or cellular mobile telephone, is provided. A second wireless device (WD2) 30 also is shown. There can, of course, be many such pervasive wireless devices within the system 1. The devices WD1 10 and WD2 30 are in radio communication with a cell sight (CS) 40, between which radio frequency information passes. The CS 40 is in communication with a network 50. The wireless pervasive device 10, 30 hosts applications that connect to web services running on remote servers such as servers 70, 80, 90, 100 for various usages such as information retrieval and data processing. Typical examples of such applications using the web service are providing the location/address of an ATM, hospital or gas station for the given zip code.

Examples of pervasive devices are two-way pagers, personal digital assistants (PDAs), cellular phones, smart appliances for the home and smart devices permanently mounted in vehicles. Typically, pervasive devices have limited processor speed, memory capacity and communication bandwidth compared to less transportable computing devices such as a desk-top computer. There is frequently a need to maximize the relatively short battery life of portable pervasive devices, which limits the addition of memory capacity or processor power to the pervasive device.

Pervasive devices 10, 30 typically have limited processing power and memory compared with computing devices that are not designed to be carried around. In general, the pervasive devices have built-in power supplies such as a battery. Accordingly, power consumption is a consideration in designing applications for the pervasive devices 10, 30, as it is undesirable for the available power to be exhausted too quickly. The power consumption of the pervasive device 10, 30 varies between standby operation and airtime. Airtime is the time during which the device 10, 30 is used for conversation and data exchange. Standby time is the time in which the pervasive device 10, 30 is ready to receive or transmit data, but is not actually being used in a call.

The devices WD1 10 and WD2 30 act as “clients” in a client-server context. The servers —providing requested web services to the clients—are formed by a composite server (CS1) 60, which is also in communication with the network 50. The CS1 60 provides intermediary functionality, having connection with a plurality of dedicated web services servers: WS1 70, WS2 80 and WS3 90. A further dedicated web services server (WS4) 100, also is in communication with the network 50.

FIG. 9 is a schematic representation of a computer system 300 of a type that is suitable for executing software for the provision of a web service. Computer software executes under a suitable operating system installed on the computer system 300, and may be thought of as comprising various software code means for achieving particular steps. The computer system 300 may be used as any of the servers 60-100. With the modifications described below, the structure of the computer system 300 may also be used in the pervasive devices 10, 30.

The components of the computer system 300 include a computer 320, a keyboard 310 and mouse 315, and a display 390. The computer 320 includes a processor 340, a memory 350, input/output (I/O) interfaces 360, 365, a video interface 345, and a storage device 355.

The processor 340 is a central processing unit (CPU) that executes the operating system and the computer software executing under the operating system. The memory 350 may include random access memory (RAM) and read-only memory (ROM), and is used under direction of the processor 340.

The video interface 345 is connected to display 390 and provides signals for display on the display 390. User input to operate the computer 320 is provided, for example, from the keyboard 310 and mouse 315. Other types of input, such as a microphone, may also be used. Signals may also be output audibly, using one or more speakers (not shown). The storage device 355 may include a disk drive or any other suitable storage medium.

Each of the components of the computer 320 is connected to an internal bus 330 that includes data, address, and control buses, to allow components of the computer 320 to communicate with each other via the bus 330.

The computer system 300 may be connected to one or more similar computers via a input/output (I/O) interface 365 using a communication channel 385 to a network, represented in FIG. 9 as the Internet 380.

The computer software may be recorded on a portable storage medium, in which case the computer software program is accessed by the computer system 300 from the storage device 355. Alternatively, the computer software can be accessed directly from the Internet 380 by the computer 320. In either case, a user can interact with the computer system 300 using, for example, the keyboard 310 and mouse 315 to operate the programmed computer software executing on the computer 320.

Other configurations or types of computer systems can be equally well used to execute computer software that assists in implementing the techniques described herein. Furthermore, custom-made devices and specialized hardware such as digital signal processors may be used in the implementation of the described techniques.

The handheld pervasive device 10, 30 may have a similar computational structure to that shown in FIG. 9. The display 390 and keypad are integrally formed in the pervasive device 10, which typically does not have a mouse 315. The I/O interface 365 in device 10 may be a transceiver for sending and receiving signals via a cellular network, and the device 10 further includes a microphone and speaker to process audible inputs and outputs.

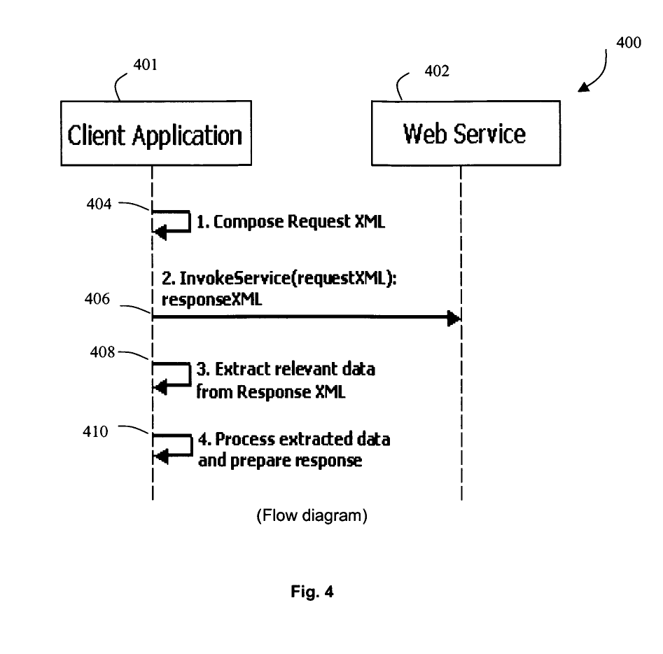

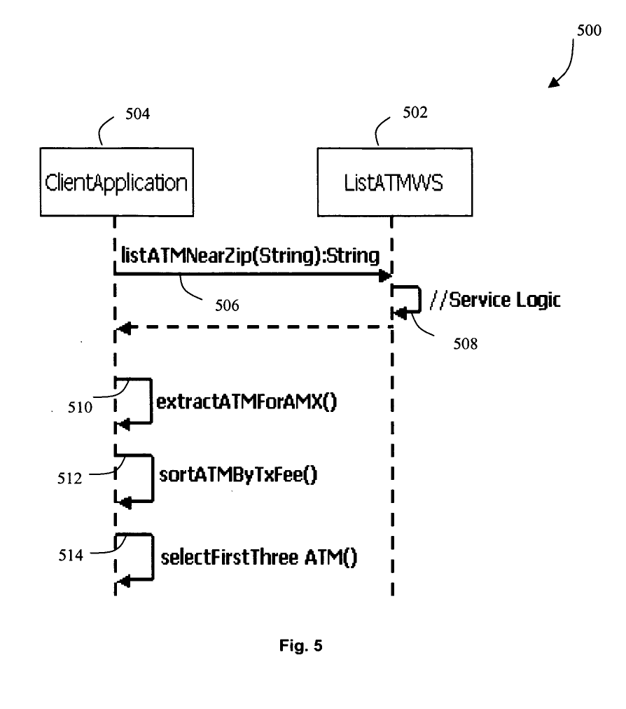

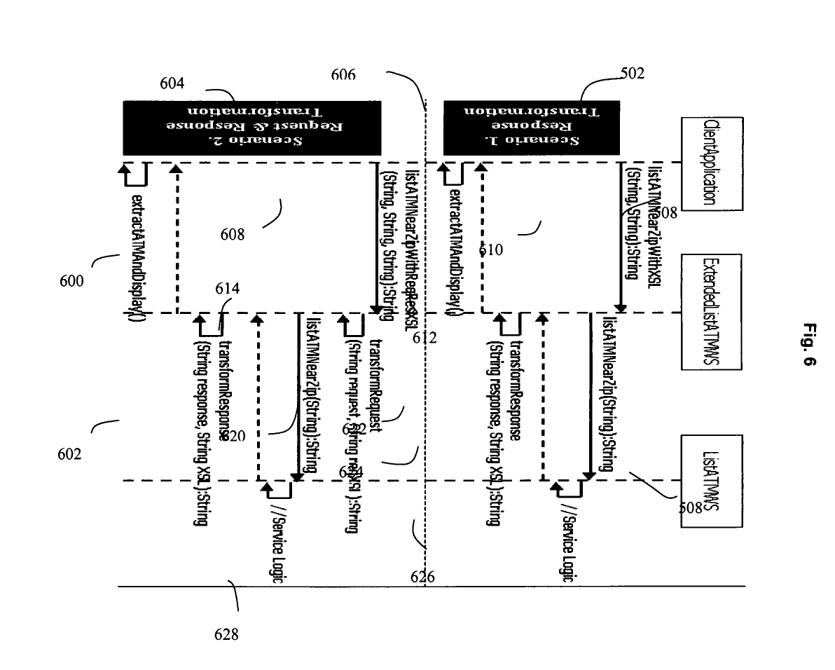

The application hosted on the wireless pervasive device 10, 30 connects to the web service over the HTTP and/or HTTPS protocol as provided by the pervasive device operating system and software and the network service provider. Once the device 10, 30 is connected to the server hosting the web service, the application can invoke the web service by referring to the name of the service and passing the required input parameters to the web service. Typically, web services provide an XML data format to specify the request and the response. The pervasive application, therefore, passes the request parameters encoded in XML as per the syntax specified by the web service. On receiving the parameters, the web service executes the request and prepares the response in pre-defined XML syntax. The response is communicated back to the application via the network 50. The web service can be implemented to execute the request synchronously or asynchronously. If the web service is synchronous, the application ‘waits’ until the time the web service executes the request and prepares the response. On receiving the response, the application parses the XML data and extracts the required information either to process the data further or present a result to the end user. FIG. 4 shows the basic flow sequence and FIG. 5 shows an example application and web service sequence diagram between an application and a web service.

FIG. 4 illustrates a base (or non-extended) method 400 performed by a client application 401 running on a pervasive device 10 in accessing a web service 402. The web service 402 has an explicitly defined request and response schema to allow any external third party application to transparently interact with the web service 402. Since the response schema is published in detail, it is programmatically easy for applications to parse and extract information from the same. If the service is developed to cater to the requirements of diverse cross-vendor applications, the service response may require data filtering to extract relevant information at the client end 10. This may create performance overheads for pervasive applications.

In step 404, the client application 401 composes the request in the format required by the web service 402. In step 406, the application 401 invokes the web service 402 and receives a response in the format specified by the web service schema. Then, in step 408, the client application extracts the relevant data from the response XML received from the web service 402. In step 410 the client application 401 processes the extracted data and prepares a response for display to the user of the pervasive device 10.

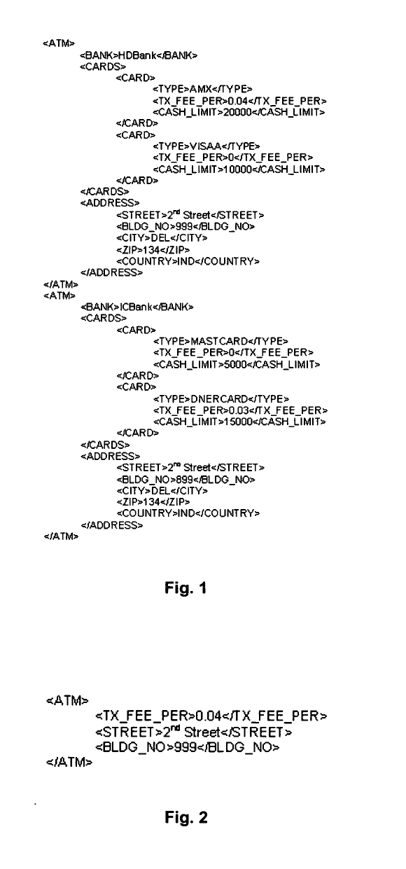

FIG. 5 illustrates the base (or non-extended) method 500 of requesting a web service, using the ATM location example for illustrative purposes. The web service running on a server is ‘ListATMWS’ 502. In initial step 506, a client application 506 running on the pervasive device 10 sends a request to the web service for a list of ATMs near a specified location. The request has the format ‘listATMNearZip(String):String’. Next, in step 508, software on the server executes to provide a response which may, for example, have the form shown in FIG. 1. The response is received by the pervasive device 10, which must then perform further processing 510, 512, 514 to extract the desired subset of information relating to AMX cards. Step 510, ‘extractATMForAMX()’, extracts information relating to ATMs that accept AMX cards. Step 512, ‘sortATMByTxFee’, then sorts the ATM locations according to the respective transaction fees. Finally, step 514, ‘selectFirstThreeATM()’, selects the three ATMs from the head of the list for display on the pervasive device 10. The resultant output may be that shown in FIG. 2.

Extended Web Service

Typically, while deploying the web service the service developer explicitly defines and publishes the request and response specification (schema) of the service to allow any external third party application to transparently interact with the web service. The directory servers are used to register the request and response specification. Since the response schema is published in detail, it is programmatically easy for applications to parse and extract information from the same. If the service is developed to cater to the requirements of diverse cross-vendor applications, the service response may require data filtering to extract relevant information at the client end. This may create performance overheads for pervasive applications. The interaction between the application and the service using such a scheme is shown in FIGS. 4 and 5 and is described above.

To benefit the pervasive devices 10, 30, the service interface of the web services is extended in a way that allows the applications running on the pervasive devices to dynamically specify the schema (syntax) of the response XML. The extended interface takes the response schema as an added input, in addition to the input parameters required by the ‘base’ service interface. This extended interface is also deployed as a web service, coupled with the original service (a.k.a. base service). This allows applications running on pervasive devices to ‘offload’ part of their ‘data parsing’ overheads to the service provider by getting the response transformed to a schema that is not only easy to parse but also relevant to the application, thus saving on the airtime and response processing time at the pervasive device 10, 30.

The extended interface can also assist to improve the performance further, by allowing the applications to offload part of their ‘data processing’ task to the service. This allows the application to pass certain post-processing instructions for the response XML to the service provider. These instructions would otherwise be processed on the pervasive device itself. The post-processing instructions allow further filtering of the response to make the response even more relevant to the application. The current XSL [http://www.w3.org/Style/xsl], XPath [http://www.w3.org/TR/xpath] and XQuery [http://www/w3.org/TR/xquery] technologies provide certain evaluation and computation functions in the transformation schema. Such functions allow applications to specify certain data processing instructions to the web service.

This response transformation is illustrated in the first scenario 600 of FIG. 4. The client application 604 runs on pervasive device 10, and the web service ‘ListATMWS’ 502 runs on one or more of the servers 60-100, together with the extended interface ‘ExtendedListATMWS’ 606. In an initial step, the client application 604 sends a request for ATM information, together with the desired XSL schema. The format of the request is ‘listATMNearZipWithXSL(String, String):String’ and the request is sent to the extended service interface 606. In turn, in step 610 the extended interface 606 sends a request 610 to the web service using the schema expected by the web service, here ‘listATMNearZip(String): String’.

In step 508 the web service extracts the requested information (e.g. the result seen in FIG. 1) and returns the result to the extended interface 606. In step 612 the extended interface 606 transforms the response according to the specified XSL schema ‘transformResponse(string response, String XSL):String’. The output of step 612 is sent to the pervasive device 10, which performs step 614, ‘extractATMAndDisplay()’, which extracts the ATM information and displays it for the user. Thus, although the final output to the user is the same, method 600 requires less memory usage and data processing in the pervasive device 10 than method 500.

The web service interface can further be extended to benefit the pervasive applications if the service request parameter schema is complex and resource intensive for the pervasive application to compose due to the hierarchical nature of the XML data model. The concept of data transformation can be applied to allow applications to send request XML parameter in a format (schema) that is simple to construct and compose for the pervasive application even though the simple schema may not be compliant with the service request parameter schema. The extended service interface allows applications to send an XSL (eXtensible Stylesheet Language) associated with the request XML parameter that can translate the application-specified request XML to the XML compatible with the web service specification at the service provider node. This allows applications to offload “data composition” overheads to formulate the complex request parameters required to interact with the service.

The second scenario 602, in which the extended service interface 606 transforms both the request and the response is shown in FIG. 4. In a first step 620, a client application 604 running on pervasive device 10 sends a service request to the extended service interface 606 ‘ExtendedListATMWS’. The request has the format:
‘listATMNearZipWithReqREsXSL(String,String,String):String’.

In step 622 the extended service interface 606 transforms the request to match the schema 15 required by the web service 502 ‘ListATMWS’. Step 622 may have the format ‘transformRequest(String request, String reqXSL):String’. The transformed request is sent to the web service 502 and, in step 508, the web service 502 issues the required information, for example the response shown in FIG. 1. Next, in step 626 (‘transformResponse(String response, String XSL):String’), the extended service interface 606 transforms the response into the form required by the client application 604. The transformed response carries processed XML elements as attributes, thus making response parsing easy and fast for pervasive application 604. Finally, in step 628 the client application 604 extracts and displays the ATM information.

The described methods allow the application 604 to efficiently exchange request and response XML data with the Web Service 502 in a format that is efficient for the application 604. The XSL can alternatively be also passed as request header to the web service.

The extended web service 606 provides a wrapper over the base web service 502 and is used to accept requests that are meant for base web service 502. The interface of the extended web service 606 is the same as that of the base service 502, having an additional two XSL parameters to:
a. transform the response of the base web service 502; and
b. compose the request to the base web service 502 using the request parameters provided by the client application 604.

The extended web service 606 is a facade to which the application 604 connects to invoke the base web service 502. The interaction between the application 604 and the extended web service 606 is similar to the interaction with the base web service 502, as described above. The additional XSL parameters passed to the extended service 606 are used to transform and compose data, thereby transferring data parsing, data processing, data composing tasks to the server.

In the scenarios described above, the extended web service 606 receives the XSL from the client application 604 at runtime. Alternatively, the schemas used by the extended web service 606 may be retrieved from a local or remote database. For example, having identified what client application 604 or pervasive device 10 is seeking to use the web service 502, the extended web service 606 may retrieve an appropriate XSL from a database. In a further alternative, the schema may be dynamically generated by the extended web service 606 based on the runtime environment characteristics of the pervasive device 10 and the application requirements.

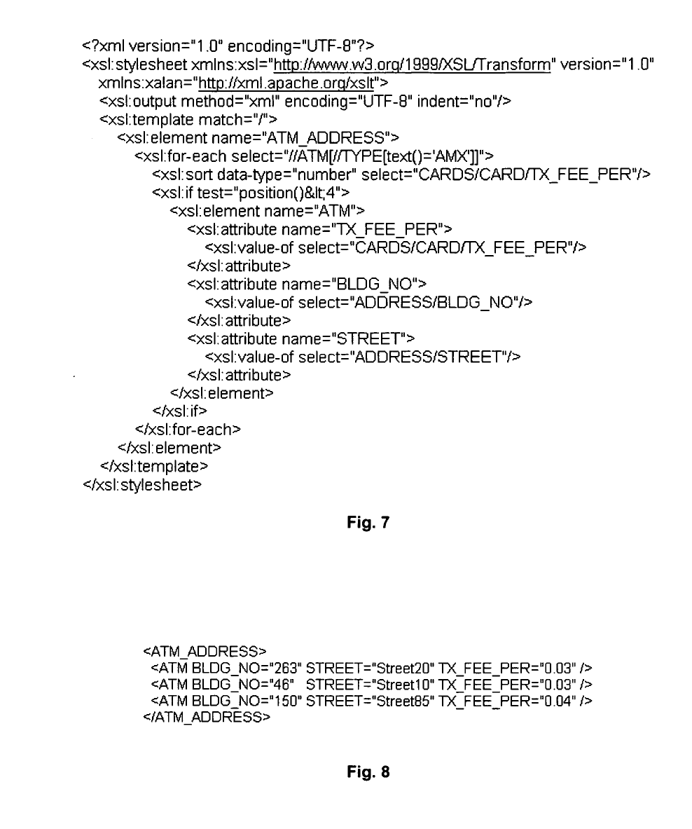

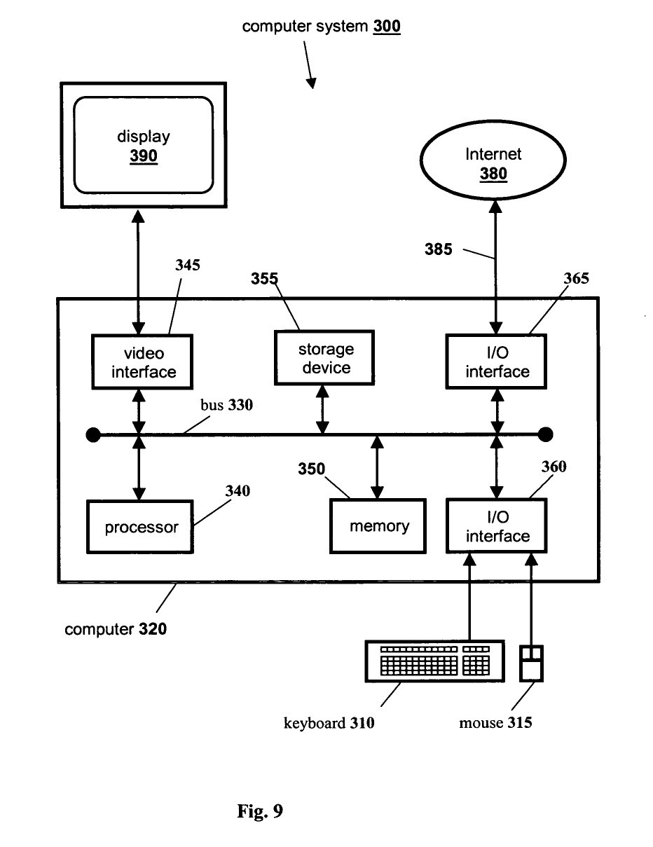

In the example used to illustrate the advantage of the proposed service extension, the web service 502 provides the list of ATMs near the given zip and country code. Different applications may consume different parts of the response to provide certain business or information value to the end user. One such application, offered by AMX Corporation, may use this service to list ATMs accepting AMX cards near the given zip and country code to its card holders. Such an application can provide a schema that allows the service provider to filter out ATMs that do not accept AMX cards, and further transform the response to a syntax that is less hierarchical and easy to parse and consume by the application. If the ATMs accepting AMX cards charge a transaction fee, then the AMX application filters the results to show three ATM locations in ascending order of transaction fee. This requires data sorting at the device end. However, using the existing XSL and XPath standards, the application can offload such data processing tasks to the extended service 606. In this case, for example, the XSL can be specified to first select ATMs that accept AMX cards (using xsl:for-each element of XSL), and then sort the list in ascending order of the transaction fee (using xsl:sort element of XSL) and then construct the response with first three ATM elements from the sorted list (using xsl:if element and position method of XSL). The XSL thus allows offloading part of the application logic to the service to improve service response time and resource utilization. This method also eliminates the earlier described overhead where the service response size is so large that the pervasive application 10, 30 cannot receive or parse the response due to the limited memory capacity of the pervasive device 10, 30. An XSL that can offload the described processing is shown in FIG. 7 and the response produced by the extended service using the XSL is shown in FIG. 8. The new response is transformed to carry processed XML elements as attributes, thus making response parsing easy and fast for pervasive application.

The support required to offload data filtering and processing tasks from the application 604 to the service 606 requires additional computation and resources from the service provider. In a commercial setup where services are offered for a fee, an extended deployment to benefit the clients may demand an additional fee over the base service. The extra cost to use the extended service is to be borne by the end user using the service. End users having devices with ample resources may not see enough benefit to pay an extra cost to use the extended service, until the point when their device is low on available resources. This leads to a requirement to allow pervasive applications perform benefit analysis to dynamically choose between the base service 502 and extended service 606 to optimize the resource utilization and amount spent to interact with the service. Using the extended service 606 may reduce the time required for the user to obtain a response from the web service. The reduced processing time may decrease the power consumed by the pervasive device 10 in obtaining the desired information.

The development of the extended service 606 may be implemented, for example, as a plugin for IBM™ WebSphere Studio Application Developer (WSAD) IDE (IBM, DB2 and WebSphere are trademarks of International Business Machines Corporation). The plugin adds a new command to extend the web service 502 and generates the code required for XML transformation for the extended service 606 using the XSLT libraries. The command may offer to create two extended services. The first extended service allows application 604 to pass the response XSL for response transformation while the second extended service allows the application 604 to pass both request and response XSL for transforming the request and response respectively.

We claim:

1. A computer-implemented method for providing an interface between a client application and a web service, said method comprising the steps of:
receiving a first request from said client application, said first request associated with a response schema specifying a format for responding to said client application;
sending a service request to said web service dependent on said first request;
obtaining an output from said web service responsive to said service request, wherein said output is in a predefined output format associated with said web service;
transforming said output to conform to said response schema; and
providing said transformed output to said client application.

2. The method according to claim 1, wherein a predefined input format is associated with said web service, said method further comprising the step of generating said service request from said first request, said generated service request conforming to said predefined input format.

3. The method according to claim 1, wherein said first request specifies one or more processing tasks and said method further comprises the step of performing said processing tasks on said output prior to said providing step.

4. The method according to claim 3, wherein said performing step filters data received from said web service dependent on at least one criterion specified in said first request.

5. The method according to claim 3, wherein said performing step reduces a size of said output provided to said client application.

6. The method according to claim 1, wherein said response schema is provided at runtime by said client application.

7. The method according to claim 1, further comprising the step of obtaining said response schema from a database.

8. The method according to claim 1 further comprising the step of generating said response schema dependent on runtime characteristics of a pervasive device on which said client application runs.

9. A computer program product comprising a storage medium readable by a computer system and recording software instructions executable by a computer system for implementing the steps of:
receiving a first request from said client application, said first request associated with a response schema specifying a format for responding to said client application;
sending a service request to said web service dependent on said first request;
obtaining an output from said web service responsive to said service request, wherein said output is in a predefined output format associated with said web service;
transforming said output to conform to said response schema; and
providing said transformed output to said client application.

10. A computer system comprising:
a processor for executing software instructions;
a memory for storing software instructions;
a system bus coupling the memory and the processor; and
a storage medium recording software instructions that are loadable to the memory for implementing the steps of:
receiving a first request from said client application, said first request associated with a response schema specifying a format for responding to said client application;
sending a service request to said web service dependent on said first request;
obtaining an output from said web service responsive to said service request, wherein said output is in a predefined output format associated with said web service;
transforming said output to conform to said response schema; and
providing said transformed output to said client application.

11. An apparatus for providing an interface between a client application and a web service, said apparatus comprising:
means for receiving a first request from said client application, said first request associated with a response schema specifying a format for responding to said client application;
means for sending a service request to said web service dependent on said first request;
means for obtaining an output from said web service responsive to said service request, wherein said output is in a predefined output format associated with said web service;
means for transforming said output to conform to said response schema; and
means for providing said transformed output to said client application.
